(19) United States
(12) Patent Application Publication
(10) Pub. No.: US 2024/0383820 A1
(43) Pub. Date: Nov. 21, 2024

(54) Biobased Micronutrient Compositions for Agricultural Processes

(71) Applicant: SOLUGEN, INC., Houston, TX (US)

(72) Inventors: Jihye Kim, Sugar Land, TX (US); Jun Su An, Houston, TX (US); Catherine Gonzalez, Houston, TX (US); Chris Arceo, Richmond, TX (US); Vatren Jurin, Overland Park, KS (US); LoongYI Tan, Houston, TX (US); Frederyk Ngantung, Houston, TX (US); Darlen Galicia, Houston, TX (US)

(73) Assignee: SOLUGEN, INC., Houston, TX (US)

(21) Appl. No.: 18/690,658

(22) PCT Filed: Sep. 20, 2022
(86) PCT No.: PCT/US2022/044159

§ 371 Date: Mar. 8, 2024

Related U.S. Application Data
(60) Provisional application No. 63/261,392, filed on Sep. 20, 2021.
(60) Provisional application No. 63/274,852, filed on Nov. 2, 2021.

(51) Int. Cl. C05G 3/00; C05C 11/00

(52) U.S. Cl. CPC C05G 3/00; C05C 11/00

(57) ABSTRACT

A micronutrient formulation comprising a biochelant, a micronutrient salt, a ring opener and a solvent. A method of treating a plant comprising applying a treatment composition comprising a biochelant, a micronutrient salt, a ring opener and a solvent to an area selected from the group consisting of foliar, soil, fertigation, chemigation, irrigation, hydroponics, aeroponic, indoor vertical farming, to the ground surrounding a plant, to plant foliage, by drip irrigation and a combination thereof wherein treatment composition comprises a biochelant, a micronutrient salt, a facilitating agent and a solvent.

### CROSS-REFERENCE TO RELATED APPLICATIONS

This application is a 35 U.S.C. § 371 national stage application of PCT/US2022/044159 filed Sep. 20, 2022, and entitled “Biobased Micronutrient Compositions for Agricultural Processes,” which claims priority to U.S. Provisional Application Ser. No. 63/261,392 filed Sep. 20, 2021 and entitled “BIOBASED IRON MICRONUTRIENT COMPOSITIONS FOR AGRICULTURAL PROCESSES,” and U.S. Provisional Application Ser. No. 63/274,852 filed Nov. 2, 2021 and entitled “PLANT NUTRIENT DELIVERY PLATFORM AND MATHODS OF MAKING AND USING SAME,” each of which is hereby incorporated herein by reference in its entirety for all purposes.

### TECHNICAL FIELD

The present disclosure relates to compositions and methods for use in agricultural processes. More specifically, the present disclosure relates to compositions for the production of nutrient blends for agricultural use.

### BACKGROUND

Agriculture is a multi-billion-dollar industry. In order to improve plant growth fertile soils are important. Herein soil fertility refers the ability of a soil to sustain plant growth by providing essential plant nutrients and favorable chemical, physical, and biological characteristics as a habitat for plant growth. In the absence of suitably fertile soil, fertilizers are often used to facilitate the growth of agricultural crops. Plants require 18 essential nutrients to grow and survive, classified by their importance into macronutrients (C, H, O, N, P, K, Ca, Mg, S, B) and micronutrients (Cu, Fe, Mn, Zn, Mo, Cl, Co, Ni). Nutrient demands change throughout the life of the plant, in general increasing during vegetative growth but decreasing during reproductive development.

Plant growth and development largely correlates with the combination and concentration of mineral nutrients available in the soil. Plants often face significant challenges in obtaining an adequate supply of these nutrients to meet the demands of basic cellular processes due to their relative immobility. A deficiency in any one of the aforementioned macronutrients or micronutrients them result in decreased plant productivity and/or decreased plant fertility. Herein plant productivity refers to the amount of plant biomass produced and is equal to all of the carbon taken up by the vegetation through photosynthesis (called Gross Primary Production or GPP) minus the carbon that is lost to respiration. Plant fertility refers to the amount of fruit or vegetation generated.

Symptoms of nutrient deficiency may include stunted growth, death of plant tissue, or yellowing of the leaves caused by a reduced production of chlorophyll. Nutrient deficiency can have a significant impact on agriculture, resulting in reduced crop yield or reduced plant quality. Nutrient deficiency can also lead to reduced overall biodiversity since plants serve as the producers that support most food webs.

One way of delivering metal micronutrients to a plant in need thereof is to form a chelated complex of the metal ion with a synthetic chelate. Such a complex maintains the metal ion in a soluble form for ease of application, reduces metal adsorption and fixation in soil, and increases solubility of the metal ion so that it can be effectively delivered to the plant utilizing any number of methods.

Chelated micronutrients improve the solubility of the cations (e.g., metals) by binding with the organic chelant to form a soluble chelated metal compound. However, there are unique challenges associated with using a chelated micronutrient. Some the metal-chelate complexes are not biodegradable, and may be poorly stable at higher pH environments. Additionally, any aqueous metal species will have a concentration of hydroxide in solution, resulting in the cation (i.e., metal) inevitably binding and forming hydroxide species. The solubility for many cations decreases as the pH increases.

Thus, conventional compositions for providing chelated micronutrients, in addition to having little to no biodegradability and reduced efficacy at higher pH, typically contain an undesirably high sodium content and lack of stability in presence of calcium (e.g. calcite and alkaline or “hard water”). Accordingly, an ongoing need exists for novel compounds that effectively chelate micronutrients and exhibit increased biodegradability, lower sodium content, and increased stability in the presence of calcium.

### SUMMARY

Disclosed herein is a micronutrient formulation comprising a biochelant, a micronutrient salt, a ring opener and a solvent.

Also disclosed herein is a method of treating a plant comprising applying a treatment composition comprising a biochelant, a micronutrient salt, a ring opener and a solvent to an area selected from the group consisting of foliar, soil, fertigation, chemigation, irrigation, hydroponics, aeroponic, indoor vertical farming, to the ground surrounding a plant, to plant foliage, by drip irrigation and combinations thereof wherein treatment composition comprises a biochelant, a micronutrient salt, a facilitating agent and a solvent.

### BRIEF DESCRIPTION OF DRAWINGS

For a detailed description of the aspects of the disclosed processes and systems, reference will now be made to the accompanying drawings in which:

For a detailed description of the aspects of the disclosed processes and systems, reference will now be made to the accompanying drawings in which:

FIG. 1 are photographs of solutions of (a) a micronutrient formulation; (b) a micronutrient formulation glucoheptonate-based micronutrient counterpart, and (c) a gluconate-based micronutrient counterpart

FIG. 2 is a photograph of humectant tests performed with a 7.7% FeSO₄ solution or a micronutrient formation of the type disclosed herein at initial plating and after 48 hrs at room temperature

FIG. 3 is a graph of the pH of a micronutrient formulation as a function of the amount of base added.

FIG. 4 is a bar graph of the amount of calcium sequestered by the indicated samples using two different types calcium salts with the first bar in each set of bars indicating the amount sequestered using calcium nitrate as the calcium source and the second bar indicating the amount sequestered using calcium chloride as the calcium source. The inset photograph is a of a humectant test comparing calcium nitrate solution to micronutrient formulations of the type disclosed herein.

FIG. 5 is a plot of the amount of calcium uptake for the indicted sample.

FIG. 6 depicts a bar graph of the root and shoot dry weight after harvest for the indicated sample.

FIG. 7 depicts a bar graph of the amount of magnesium and boron nutrients uptake determined for the indicted sample where the first bar in each set of bars indicates the shoot weight and the second bar indicates the root weight.

FIG. 8 depicts a bar graph of the amount of manganese and boron nutrients uptake determined for the indicted sample where the first bar in each set of bars indicates the percentage manganese and the second bar indicates the percentage boron. Single bars are the percentage manganese.

FIG. 9 depicts a bar graph of the amount of molybdenum and boron nutrients uptake determined for the indicted sample where the first bar in each set of bars indicates the percentage molybdenum and the second bar indicates the percentage boron. Single bars are the percentage manganese.

FIG. 10 depicts a bar graph of the amount of zinc nutrient uptake determined for the indicted sample.

FIG. 11 is a photograph of humectant tests comparing zinc sulfate solution to micronutrient formulations of the type disclosed herein after 1 day.

FIG. 12 is a bar graph depicting the nutrient uptake for plants treated with the indicated samples where for each set of bars the first bar in the set indicates the percentage zinc, the second bar in the set indicates the percentage boron, the third bar in the set indicates the percentage nitrogen and the fourth bar in the set indicates the percentage sulfur.

FIG. 13 depicts a bar graph of the amount of zinc and boron nutrients uptake in the corns foliar treated with the indicated formulations.

FIG. 14 depicts photographs of corn roots treated with micronutrient formulations of the type disclosed herein.

### DETAILED DESCRIPTION

Disclosed herein is a micronutrient formulation comprising a biochelant, a nutrient salt and a solvent. The micronutrient formulation of the present disclosure is characterized by an iron content of equal to or greater than about 5%, biodegradability, pH stability, stability in the presence of calcium and a low potassium content. Each of these characteristics will be defined in more detail later herein.

In an aspect, the micronutrient formulation comprises a chelant or sequestering agent which is a molecule capable of bonding or forming a complex with a metal. The chelant may be characterized as a ligand that contains two or more electron-donating groups so that more than one bond is formed between an atom on each of the electron donating groups of the ligand to the metal. This bond can also be dative or a coordinating covalent bond meaning each electronegative atom provides both electrons to form bonds to the metal center. In one or more aspects, the chelant is a molecule able to chelate a metal, as described, and (i) is sourced from a natural resource, (ii) is biodegradable, or (iii) both and is hereinafter termed a biochelant. In an aspect, the biochelant comprises aldonic acid, uronic acid, aldaric acid, or combinations thereof and a counter cation. For example, the biochelant may be a mixture of aldaric, uronic acids, and their respective counter-cations.

In another aspect, the biochelant comprises a glucose oxidation product, a gluconic acid oxidation product, a gluconate, or combinations thereof. The glucose oxidation product, gluconic acid oxidation product, or combination thereof may be buffered to a suitable pH.

Additionally, or alternatively, in one or more aspects, the biochelant comprises glucaric acid, gluconic acid, glucuronic acid, glucose oxidation products, gluconic acid oxidation products or combinations thereof. Additionally, or alternatively, in one or more aspects, the biochelant comprises disaccharides, oxidized disaccharides, uronic acid, aldaric acid or combinations thereof.

Additionally, or alternatively, in one or more aspects, the biochelant comprises gluconic acid, glucaric acid, glucuronic acid, n-keto-acids, C₂ to C₆ diacids or combinations thereof.

Additionally, or alternatively, in one or more aspects, the biochelant comprises galactonic acid, galactaric acid, an oxidation product comprising predominantly (e.g., greater than about 50 weight percent) galactonic acid and/or galactaric acid with minor component species of n-keto-acids, C₂ to C₆ diacids, or combinations thereof. Additionally, or alternatively, in one or more aspects, the biochelant comprises glutamic acid. Additionally, or alternatively, in one or more aspects, the biochelant comprises glucodialdose, 2-ketoglucose, or combinations thereof.

In such aspects, the buffered glucose oxidation product, the buffered gluconic acid oxidation product, or combinations thereof are buffered to a suitable pH. For example, the glucose oxidation product, gluconic acid oxidation product or combination thereof may be buffered to a pH in the range of from about 1 to about 5. Buffering of the biochelant may be carried using any suitable acid, base, or combination thereof.

In one or more aspects, a biochelant comprises aldonic acid, uronic acid, aldaric acid, a gluconic acid oxidation product, a gluconate, glucaric acid, gluconic acid, glucuronic acid, glucose oxidation products, galactonic acid, galactaric acid, glutamic acid, a lactone of gluconic acid, a lactone of glucaric acid, a lactone of galactaric acid, a lactone of galactonic acid, glucodialdose, 2-ketoglucose, disaccharides, oxidized disaccharides, n-keto-acids, C₂ to C₆ diacids, salts thereof, or combinations thereof.

In one or more aspects, any biochelant or combination of biochelants disclosed herein may further comprise a counter-cation such as a Group 1 alkali metal, a Group 2 alkaline earth metal, a Group 8 metal, Group 11 metal, Group 12 metal, or combinations thereof. For example, the counter-cation may comprise silicates, borates, aluminum, calcium, magnesium, ammonium, sodium, potassium, cesium, strontium, zinc, copper, ferric iron or ferrous iron, or combinations thereof.

In an aspect, the biochelant comprises a glucose oxidation product, a gluconic acid oxidation product, a gluconate, glucaric acid, an oxidized glucuronolactone, a uronic acid oxidation product, or combinations thereof. Alternatively, the biochelant comprises a buffered glucose oxidation product, a buffered gluconic acid oxidation product, or combinations thereof. In some such aspects, the buffered glucose oxidation product, the buffered gluconic acid oxidation product, or combination thereof are buffered to a pH within a range disclosed herein with any suitable acid or base such as sodium hydroxide. In an example of such aspects, the biochelant comprises a mixture of gluconic acid and glucaric acid, and further comprises a minor component species comprising n-keto-acids, C₂-C₆ diacids, or combinations thereof. In an aspect, the biochelant comprises a metal chelation product commercially available from Solugen, Inc. of Houston, Texas as Biochelate™ and NutriValent™.

In various aspects, the biochelant may be present in a micronutrient formulation in an amount of from about 0.1 weight percent (wt. %) to about 99 wt. %, alternatively from about 0.1 wt. % to about 90 wt. %, alternatively from about 1 wt. % to about 80 wt. %, alternatively from about 5 wt. % to about 75 wt. %, alternatively from about 10 wt. % to about 50 wt. %, alternatively from about 45 wt. % to about 99 wt. %, alternatively from about 1 wt. % to about 10 wt. %, alternatively from about 0.1 wt. % to about 2 wt. % or alternatively from about 5 wt. % to about 60 wt. % based on the total weight of the micronutrient formulation. Herein, all weight percentages are based on the total weight of the composition being described unless indicated otherwise.

In an aspect, the micronutrient formulation comprises a micronutrient salt comprising a metal cation and an anion such as a sulfate, a sulfite, an oxide, a chloride, a nitrate, a nitrite, a phosphate, phosphorous, a phosphonate, or combinations thereof. In some aspects, the micronutrient salt comprises oxides of iron, magnesium, manganese, copper, zinc, calcium, potassium, or combinations thereof. In an aspect, the micronutrient salt comprises an iron cation, a potassium cation or both with an anion.

In an aspect, the micronutrient salt comprises humic acids, fulvic acids, salts thereof, or combinations thereof. Herein humic and fulvic acids refer to the final break-down constituents of the natural decay of plant and animal materials. Humic matter is formed through the chemical and biological humification of plant and animal matter and through the biological activities of micro-organisms. Humic acids are complex molecules that exist naturally in soils, peats, oceans and fresh waters.

In an aspect, the micronutrient formulation comprises an additional salt. Nonlimiting examples of compounds that may be useful as the additional salt may have cations such as calcium, boron, magnesium, manganese, copper, zinc, and anions such as potassium and ani phosphates, phosphorous, chloride, sulfates, nitrates, and nitrites. In an aspect, the total metal content of the micronutrient formulation (e.g., micronutrient salt + additional salt) ranges from about 0.5 wt. % to 50 wt. % based on the total weight of the micronutrient formulation, alternatively from about 1 wt. % to about 50 wt. % or alternatively from about 5 wt. % to about 30 wt. %.

In an aspect, the micronutrient formulation, optionally, comprises a ring-opener. Without wishing to be limited by theory, the ring opener may function to stabilize the acid form of the biochelant, which is in constant equilibrium with the lactone form of the molecule. The acid form may be more effective for chelating cations. In an aspect, the micronutrient formulation comprises a compound that functions to shift the equilibrium of the acid-lactone forms of the chelant to favor retention of the linear acid (e.g., glucaric acid) and ensure the amount of the lactone form is minimized. Specifically, the ring opener may facilitate stabilization of the lactone form of the complexing agent and increase the ability of polyhydroxycarboxylates to coordinate a metal nutrient. In such aspects, the ring opener enables complexation with a higher amount of nutrient on a single molecule of micronutrient formulation.

In an aspect, the ring opener comprises an oxoacid salt, an amide, or combinations thereof. For example, the ring opener may comprise silicic acid, sodium silicate, potassium silicate, monosilicate, silanes, siloxanes, amino acids, urea, boric acid, aluminates, stannates, titanates, urea, acetamide, ethanamide, derivatives thereof, or combinations thereof. In an aspect, the urea derivatives comprise methylol urea, imidazolidinyl urea, ethylene urea, diazolidnyl urea, or combinations thereof.

In an aspect, the ring opener comprises boron, borate or derivatives thereof. In an aspect, the borate derivatives comprise borax, sodium borates (metaborate, perborate), potassium borates, diammonium tetraborate, boron trioxide, or combinations thereof. The ring-opener may be present in the micronutrient formulation in an amount ranging from about 2 wt. % to about 95 wt. %, alternatively from about 5 wt. % to about 95 wt. %, alternatively from about 2 wt. % to about 80 wt. %, alternatively from about 10 weight percent (wt. %) to about 40 wt. %, alternatively from about 2 wt. % to about 30 wt. % or alternatively from about 30 wt. % to about 80 wt. % based on to total weight of the micronutrient formulation.

In some aspects, a micronutrient formulation comprises an optional facilitating agent. Herein a facilitating agent refers to a material that increases the solubility of the metal (e.g., iron) in solution. Any material able to increase the solubility of a metal of interest in solution may be utilized as a facilitating agent. In an aspect, the facilitating agent comprises sodium citrate, potassium citrate, potassium gluconate, or combinations thereof. The facilitating agent may be used in the micronutrient formulation in any amount effective to increase the solubility of the metal ion in solution. In an amount, the facilitating agent is present in an amount ranging from about 0.01 wt. % to about 10 wt. %, alternatively from about 00.5 wt. % to about 10 wt. %, or alternatively from about 5 wt. % to about 10 wt. %.

In an aspect, the micronutrient formulation comprises a solvent. Solvents suitable for use in the micronutrient formulation include without limitation water, a citrate solution, or combinations thereof. In an aspect, the solvent is present in an amount sufficient to meet some user and/or process need (e.g., flow properties). In an aspect, the solvent is present in an effective amount; alternatively, the solvent comprises the remainder of the micronutrient formulation when all other components of the micronutrient formulation are accounted for. For example, the solvent may be present in an amount of from about 1 wt. % to about 99 wt. %, alternatively about 10 wt. % to about 50 wt. %, or alternatively from about 99 wt. % to about 1 wt. %.

In an aspect, the micronutrient formulation is biodegradable. The term “biodegradable” refers to a material which can be chemically decomposed (broken down to simpler components) by natural biological processes (e.g. soil bacteria, weather, plants, animals). In an aspect, the micronutrient formulation of the present disclosure is biodegradable where about 89% of theoretical oxygen demand (ThOD) for the micronutrient formulation has occurred after 28 days when measured in accordance with Aerobic-Directive 92/69/EEC, C.4-E and/or 100% biodegradable under anaerobic conditions after 35 days when measured in accordance with Anaerobic DIN EN ISO 11734. The ThOD is the total amount of oxygen required to completely oxidize a known compound to CO₂ and H₂O. In another aspect, the micronutrient formulation of the present disclosure is biodegradable where about 89% of theoretical oxygen demand (ThOD) for the micronutrient formulation has occurred after 28 days when measured in accordance with Aerobic-Directive 92/69/EEC, C.4-E and/or 100% biodegradable under anaerobic conditions after 35 days when measured in accordance with Anaerobic DIN EN ISO 11734.

In an alternative aspect, the micronutrient formulation of the present disclosure is biodegradable where the ThOD for the micronutrient formulation has occurred after 28 days when measured in accordance with Aerobic-Directive 92/69/EEC, C.4-E.

In an aspect, the micronutrient formulations of the present disclosure are pH stable and effective over the pH range of from about 1 to about 12, alternatively from about 6 to about 9, alternatively from about 1 to about 3 or, alternatively from about 8 to about 12.

In an aspect, the micronutrient formulations of the present disclosure are characterized by a low sodium ion concentration. For example, the micronutrient formulations may have a sodium concentration in the range of from about 1 ppm to about 50 ppm, alternatively from about 2 ppm to about 4 ppm or alternatively from about 5 ppm to about 30 ppm.

In an aspect, the micronutrient formulations of the present disclosure are capable of sequestering an increased amount of iron when compared to micronutrient formulations having a conventional biochelant. For example, the micronutrient formulation of the present disclosure sequesters iron in an amount that is equal to or greater than about 5 wt. % of the amount of iron sequestered by a biochelant other than those disclosed herein for use in the micronutrient formulation, alternatively from about 5 wt. % to about 20 wt. % or alternatively from about 5 wt. % to about 20 wt. %.

In an aspect, the micronutrient formulation is blended with one or more additional components to provide a material suitable for application to a plant. Hereinafter this is referred to as a “treatment composition.”

In such aspects, the treatment composition comprises the micronutrient formulation and at least one compound to facilitate the function of the micronutrient formulation, hereinafter termed a performance enhancer. In an aspect, the performance enhancer is selected from the group consisting of nitrates, nitrites, phosphates, sulfates, insecticides, herbicides, fungicides, macronutrients, plant hormones, dry fertilizer, liquid fertilizers, adjuvants, bio-stimulants, surfactants, oxidizers, biologicals, water treatment/irrigation products, plant hormones and combinations thereof. For example, the micronutrient formulation may be combined with a preplant fertilizer, macronutrients and plant hormones. In an aspect, the performance enhancer (singularly or in combination) may be present in the treatment composition in an amount ranging from about 5% to about 95%, alternatively from about 15% to about 85%, or alternatively from about 25% to about 75%.

In one or more aspects, the micronutrient formulation is used as a building block additive in order to formulate and manufacture additional micronutrients. The presently disclosed micronutrient formulation allows for unique nutrient ratios not commonly possible with complexing agents.

In an aspect, a micronutrient formulation of the present disclosure is prepared as a treatment composition, in either liquid or solid form. In such aspects, the micronutrient formulation may be present in the treatment composition in nanomolar concentrations, such as from about 10 nm to about 500 nm, alternatively from about 50 nm to about 250 nm or alternatively about 100 nm. The remainder of the treatment composition may comprise any material that facilitates utilization of the treatment composition for the intended application and compatible with the components of the micronutrient formulation.

The present disclosure contemplates contacting of the treatment composition with a plant using any suitable methodology such as and without limitation foliar, soil, fertigation, chemigation, irrigation, hydroponics, aeroponic, indoor vertical farming, and other applications. In an aspect, the treatment composition is applied to the ground surrounding a plant or to the foliage of the plant using any suitable methodology to deliver the readily absorbable trace metals present in the treatment composition to the plant tissue. For example, the treatment composition (comprising a micronutrient formulation of the type disclosed herein) may be contacted with plants by introduction to an irrigation system for application by drip irrigation.

Other nonlimiting examples of methods for contacting the treatment composition with a plant include the direct spray of a diluted aqueous solution of the treatment compositon on the leaves, stems, and fruits of a plant, injection of the treatment composition into the soil, injection of the treatment composition into the water culture, circulation of the treatment composition past an absorbent such as rock wool which is held in direct contact with the roots of a plant, continuous addition of the treatment composition to the feed water of a plant, or combinations thereof.

In aspects in which the treatment composition is a liquid, it may be sprayed or poured onto the base growing. In aspects in which the treatment composition is a solid, it may be spread onto the surface of the base growing medium or it may be mixed into the base growing medium. Herein base growing medium refers to a standard material that is commonly used to grow plants, for example soil or compost. Alternatively, the treatment composition may be contacted with a part of a plant that is above the ground, for example the leaves, flowers, fruit or stem.

The treatment compositions disclosed herein may be applied to virtually any variety of plant shoots, roots, seeds, tissues, suspension cultures or thalli. The micronutrient formulation can be applied to all photosynthetic organisms such as flowering plants, including angiosperms and gymnosperms, and cryptograms, including ferns, liverworts, mosses, algae and hornworts. In particular, the micronutrient formulation may be advantageously applied to higher plants, including species having true stems, roots and leaves.

Examples of plants which may benefit from the micronutrient formulations of the present disclosure include all crop plants such as alfalfa, anise, bach ciao, barley, basil, blueberry, breadfruit, broccoli, brussels sprouts, cabbage, cassava, cauliflower, celery, cereals, cilantro, coffee, corn, cotton, cranberry, cucumber, dill, eggplant, fennel, grape, grain, garlic, kale, leek, legume, lettuce, melon, mint, mustard, melon, oat, onion, parsley, peanut, pepper, potato, saffron, legume, lettuce, millet, parsnip, pea, pepper, peppermint, pumpkin, radish, rice, sesame, sorghum, soy, spinach, squash, stevia, strawberry, sunflower, sweet potato, sugar beet, sugar cane, tea, tobacco, tomato, turnip, wheat, yam, zucchini and the like; pomes and other fruit-bearing plants such as apple, avocado, banana, breadfruit, cherry, citrus, cocoa, fig, guava, macadamia, mango, mangosteen, nut, olive, papaya, passion fruit, pear, pepper, plum, peach and the like; floral plants such as achillea, ageratum, alyssum, anemone, aquilegia, aster, azalea, begonia, bird-of-paradise, bleeding heart, borage, bromeliad, bougainvillea, buddlea, cactus, calendula, camellia, campanula, carex, carnation, celosia, chrysanthemum, clematis, cleome, coleus, cosmos, crocus, croton, cyclamen, dahlia, daffodil, daisy, day lily, delphinium, dianthus, digitalis, dusty miller, euonymus, forget-me-not, fremontia, fuchsia, gardenia, gazania, geranium, gerbera, gesneriad, ginkgo, gladiolus, hibiscus, hydrangea, impatiens, jasmine, lily, lilac, lisianthus, lobelia, marigold, mesembryanthemum, mimulus, myosotis, New Guinea Impatiens, nymphaea, oenothera, oleander, orchid, oxalis, pansy, penstemon, peony, petunia, poinsettia, polemonium, polygonum, poppy, portulaca, primula, ranunculus, rhododendron, rose, salvia, senecio, shooting star, snapdragon, solanum, solidago, stock, ti, torenia, tulip, verbena, vinca, viola, violet, zinnia, and the like; leafy plants such as ficus, fern, hosta, philodendron, and the like, trees such as Abies, birch, cedar, Cornus, cypress, elm, fir, juniper, magnolia, mahogany, maple, oak, palm, Picea, Pinus, Pittossporum, Plantago, poplar, redwood, Salix, sycamore, Taxus, teak, willow, yew, Christmas tree and the like; grasses, such as Kentucky blue grass, bent grass, turf, festuca, pennisetum, phalaris, calamogrostis, elymus, helictotrichon, imperata, molina, carex, miscanthus, panicum and the like; and thalloid plants such as ferns and algae. Algae include seaweeds such as kelp, Eucheuma, laver, nori, kombu and wakame. Other plants, which may benefit from application of the micronutrient formulation of the present disclosure will be apparent to those skilled in the art.

In an aspect, utilization of micronutrient formulations of the type disclosed herein result in enhanced plant productivity as demonstrated by increased growth rate, increased biomass, higher yields and quality (protein content), accelerated rate of root formation, increased tillering, increased chlorophyll concentration and the like indicia. In an aspect, the micronutrient formulation is a humectant. A humectant refers ti a hygroscopic substance used to keep things moist.

### ADDITIONAL DISCLOSURE

The following are non-limiting, specific aspects in accordance with the present disclosure:

A first aspect which is a micronutrient formulation comprising a biochelant, a micronutrient salt, a ring opener and a solvent.

A second aspect which is the micronutrient formulation of the first aspect wherein the biochelant comprises an aldonic acid, uronic acid, aldaric acid, galactonic acid, galactaric acid oxidation product comprising predominantly galactonic acid, galactaric acid with minor component species of n-keto-acids and C₂-C₆ diacids or combinations thereof.

A third aspect which is the micronutrient formulation of any of the first through second aspects wherein the biochelant further comprises a counter cation.

A fourth aspect which is the micronutrient formulation of the third aspect wherein the counter cation comprises a Group 1 alkali metal, a Group 2 alkaline earth metal, a Group 8 metal, a Group 11 metal, a Group 12 metal or combinations thereof.

A fifth aspect which is the micronutrient formulation of the third aspect wherein the counter cation comprises silicates, borates, aluminum, calcium, magnesium, ammonium, sodium, potassium, cesium, strontium, zinc, copper, ferric iron or ferrous iron, or combinations thereof.

A sixth aspect which is the micronutrient formulation of any of the first through fifth aspects wherein the biochelant comprises a buffered glucose oxidation product, a buffered gluconic acid oxidation product or combinations thereof.

A seventh aspect which is the micronutrient formulation of the sixth aspect wherein the buffered glucose oxidation product, the buffered gluconic acid oxidation product or combinations thereof further comprises n-keto-acids, C₂-C₆ diacids or combinations thereof.

An eighth aspect which is the micronutrient formulation of any of the first through seventh aspects wherein the biochelant is present in an amount of from about 0.1 weight percent (wt. %) to about 99 wt. % based on the total weight of the formulation.

A ninth aspect which is the micronutrient formulation of any of the first through eighth aspects wherein the micronutrient salt comprises boron, iron, cobalt, copper, magnesium, manganese, zinc, potassium, aluminum, urea, calcium, molybdenum, or combinations thereof.

A tenth aspect which is the micronutrient formulation of any of the first through ninth aspects wherein the micronutrient salt comprises, oxides of iron, magnesium, manganese, copper, zinc, calcium, potassium, or combinations thereof.

An eleventh aspect which is the micronutrient formulation of any of the first through tenth aspects wherein the micronutrient salt comprises humic acids, fulvic acids, salts thereof, or combinations thereof.

A twelfth aspect which is the micronutrient formulation of any of the first through eleventh aspects wherein the ring opener comprises oxoacid salt, an amide, or combinations thereof.

A thirteenth aspect which is the micronutrient formulation of any of the first through twelfth aspects wherein the ring opener comprises silicic acid, sodium silicate, potassium silicate, monosilicate, silanes, siloxanes, amino acids, urea, boric acid, aluminates, stannates, titanates, urea, acetamide, ethanamide, derivatives thereof, or combinations thereof.

A fourteenth aspect which is the micronutrient formulation of any of the first through thirteenth aspects wherein the ring opener comprises methylol urea, imidazolidinyl urea, ethylene urea, diazolidnyl urea, or combinations thereof.

A fifteenth aspect which is the micronutrient formulation of any of the first through fourteenth aspects wherein the ring opener comprises boron, borate borax, sodium borates, metaborate, perborate, potassium borates, diammonium tetraborate, boron trioxide, or combinations thereof.

A sixteenth aspect which is the micronutrient formulation of any of the first through fifteenth aspects further comprising an optional facilitating agent.

A seventeenth aspect which is the micronutrient formulation of any of the first through sixteenth aspects wherein the optional facilitating agent comprises sodium citrate, potassium citrate, potassium gluconate, or combinations thereof.

An eighteenth aspect which is the micronutrient formulation of any of the first through seventeenth aspects wherein the solvent comprises water, a citrate solution, or combinations thereof.

A nineteenth aspect which is a method of treating a plant comprising applying a treatment composition comprising a biochelant, a micronutrient salt, a ring opener and a solvent to an area selected from the group consisting of foliar, soil, fertigation, chemigation, irrigation, hydroponics, aeroponic, indoor vertical farming, to the ground surrounding a plant, to plant foliage, by drip irrigation, and combinations thereof wherein treatment composition comprises a biochelant, a micronutrient salt, a facilitating agent and a solvent.

A twentieth aspect which is the method of the nineteenth aspect wherein the biochelant comprises an aldonic acid, uronic acid, aldaric acid, galactonic acid, galactaric acid oxidation product comprising predominantly galactonic acid, galactaric acid with minor component species of n-keto-acids and C₂-C₆ diacids, or combinations thereof.

A twenty-first aspect which is the method of any of the nineteenth through twentieth aspects wherein the micronutrient salt comprises boron, iron, cobalt, copper, magnesium, manganese, zinc, potassium, aluminum, urea, calcium, molybdenum, or combinations thereof.

A twenty-second aspect which is the method of any of the nineteenth through twenty-first aspects wherein the ring opener comprises oxoacid salt, an amide, or combinations thereof.

A twenty-third aspect which is the method of any of the nineteenth through twenty-second aspects wherein the ring opener comprises silicic acid, sodium silicate, potassium silicate, monosilicate, silanes, siloxanes, amino acids, urea, boric acid, aluminates, stannates, titanates, urea, acetamide, ethanamide, derivatives thereof, or combinations thereof.

A twenty-fourth aspect which is the method of any of the nineteenth through twenty-third aspects wherein the ring opener comprises methylol urea, imidazolidinyl urea, ethylene urea, diazolidnyl urea, or combinations thereof.

A twenty-fifth aspect which is the method of any of the nineteenth through twenty-fourth aspects wherein the ring opener comprises boron, borate borax, sodium borates, metaborate, perborate, potassium borates, diammonium tetraborate, boron trioxide, or combinations thereof.

### EXAMPLES

The subject matter having been generally described, the following examples are given as particular aspects of the disclosure and are included to demonstrate the practice and advantages thereof. Those of skill in the art should, in light of the present disclosure, appreciate that many changes can be made in the specific aspects which are disclosed and still obtain a like or similar result without departing from the scope of the subject matter of the instant disclosure. It is understood that the examples are given by way of illustration and are not intended to limit the specification of the claims to follow in any manner.

### Example 1

The ability of a micronutrient formulation to complex iron was investigated. A micronutrient formulation of the type disclosed herein was prepared, designated MicroForm-1, and comprised a mixture of gluconic acid, glucaric acid and a facilitating agent (e.g., sodium citrate). The contents of Fe and S in the final solution are shown in Table 1 along with the pH of the solution. The values were reported in terms of the claimed amount of iron present and the amount determined using ion coupled plasma (ICP) analysis.

TABLE 1

Fe (wt %)

| Label | Final pH | Claimed | ICP | S (wt %) |
|---|---|---|---|---|
| MicroForm-1 | 3.06 | 6.7 | 5.8 | 3.9 |
| Fe-EDTA | | 5 | 6 | |
| Fe-gluconate | | 5 | 1.9 | |

MicroForm-1 was found to be competitive with regards to iron chelation when compared to iron chelation by EDTA or gluconate.

### Example 2

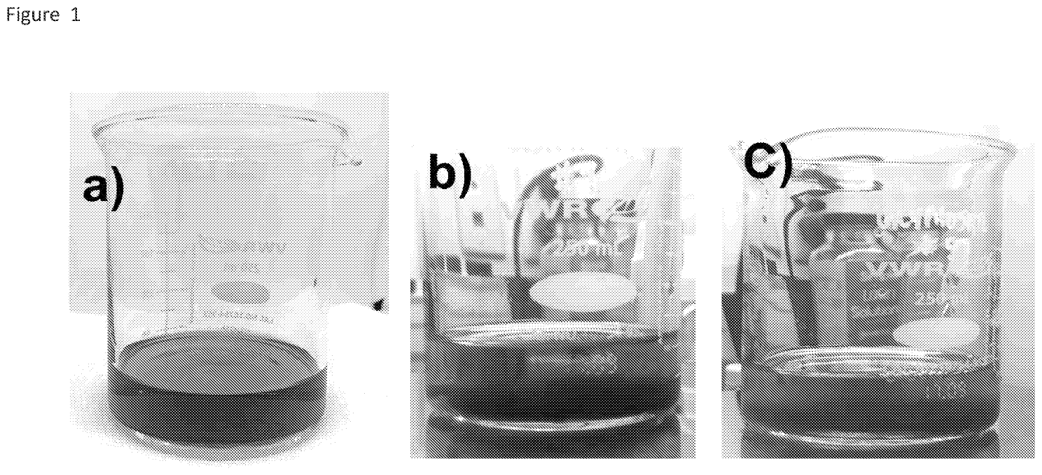

The compatibility of a micronutrient formulation with materials commonly used in agricultural processes was investigated. Specifically, a micronutrient formulation's compatibility with a fertilizer and herbicide was determined. MicroForm 1 was blended with glyphosate (a herbicide) and an ortho phosphate-based plant food to prepare a sample designated Microblend 1. Microblend 1 (3 g) was added to 50 g of the indicated test solution, which was then mixed, and the clarity of the solution observed. As shown in FIG. 1a, the glyphosate solution mixed with when mixed with Microblend 1 showed good compatibility as no phase separation was observed. However, the counterpart micronutrient blends formulated with glucoheptonate or gluconate, FIGS. 1b and 1c respectively, turned hazy and precipitated when mixed with glyphosate within 7 to 27 seconds. The formation of haze and precipitate indicated that unlike Microblend 1, glucoheptonate and gluconate were incompatible with the herbicide, glycophosphate.

### Example 3

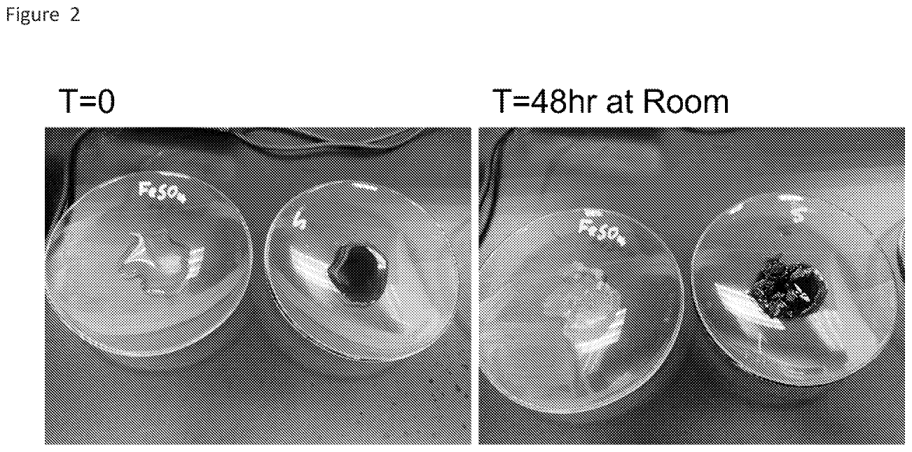

The ability of MicroForm-1 to act as a natural humectant was investigated. Specifically. MicroForm-1 was compared to 7.7% iron sulfate solution. Specifically, 3 mL of the aforementioned fluids was placed on a watch glass, and then placed at standard temperature and pressure (STP) conditions for 48 hrs. The results are presented in FIG. 2. As seen in the FIG. 2, the iron sulfate completely dried within 48 hrs, while the MicroForm-1 solution was still liquid. This indicated that MicroForm-1 solution holds water more effectively when compared to the iron salt dissolved in water, acting as a natural humectant. These results suggest that the MicroForm-1 solution would allow for plants to hold water on the leaf surface for a longer time when applied as foliar application, facilitating more efficient leaf absorption.

### Example 4

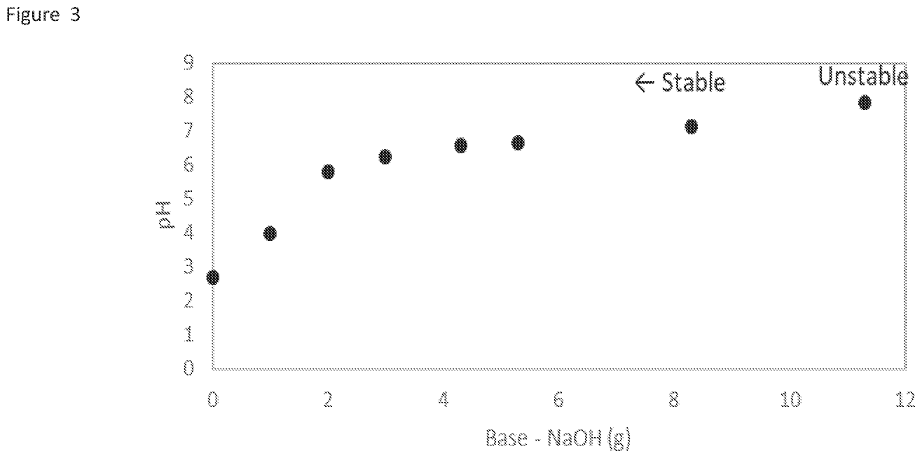

The pH stability of a MicroForm-1 solution was investigated. Specifically, NaOH was added to the product until the solution becomes unstable as evidenced by the formation of a precipitate. The results are presented in FIG. 3 as a plot of pH of the sample solution as a function of added NaOH which demonstrates the product was stable below pH 8.

### Example 5

A new micronutrient formulation of the type disclosed herein was prepared. The new micronutrient formulation contained iron sulfate heptahydrate (FeSO₄·7H₂O), glucaric acid, boric acid, and ammonium were used to formulate a 2-in-1 iron and boron combination product that contained about 2.3 wt. % to 3.6 wt. % iron and 0.04 wt. % to 2.2 wt. % boron in one molecule. Table 2 shows the following details of the different formulations and formulation conditions: 1) the targeted ratios between glucaric acid to iron sulfate in formulation, 2) the target ratio between boric acid to glucaric acid in reaction, 3) the percentage of the elements that are important in fertilizer products, 4) formulation pH and stability, and 5) formulation compatibility with a lawn solution comprising orthophosphate or a herbicide comprising glyphosate. Glucaric acid was used to complex iron. Boric acid was used to esterify the hydroxy groups and connect two molecules of glucaric acid together, while serving as a ring opener of lactone form of glucaric acid in solution at the same time, facilitating the efficiency of the reaction.

TABLE 2

| | Formulation | | | | | | Product | | Compatibility test | |
|---|---|---|---|---|---|---|---|---|---|---|
| | Ratio | Ratio | Element % | | | | Final | | Lawn | Glyphosate |
| Blend Name | of GA:Fe | of BA:GA | % Fe | N % | B % | S % | pH | Stability | solution | Herbicide |
| FeSO4-B-GA50-17 | 1.0 | 0.06 | 3.5% | 6.6% | 0.04% | 2.0% | 10.64 | Stable | NA | NA |
| FeSO4-B-GA50-18 | 2.0 | | 3.6% | 3.2% | 0.1% | 2.1% | 7.71 | Stable | NA | NA |
| FeSO4-B-GA50-19 | 1.0 | 0.13 | 2.7% | 7.8% | 0.1% | 1.6% | 11.1 | Stable | NA | NA |
| FeSO4-B-GA50-20 | 2.0 | | 3.3% | 3.9% | 0.2% | 1.9% | 9.27 | Stable | NA | NA |
| FeSO4-B-GA50-4 | 2.0 | 0.25 | 3.5% | 3.3% | 0.3% | 2.0% | 7.8 | Stable | Clear | NA |
| FeSO4-B-GA50-8 | 2.0 | 0.50 | 2.3% | 6.2% | 0.4% | 1.3% | 10.7 | Stable | Clear | NA |
| FeSO4-B-GA50-12 | 2.0 | 1.0 | 3.0% | 4.0% | 1.2% | 1.7% | 8.0 | Stable | Murky | NA |
| FeSO4-B-GA50-15 | 1.0 | 2.0 | 2.6% | 7.5% | 1.0% | 1.5% | 10.8 | Stable | Clear | NA |
| FeSO4-B-GA50-16 | 2.0 | | 2.8% | 3.7% | 2.2% | 1.6% | 9.6 | Stable | NA | NA |

The effectiveness of other micronutrient formulations of the type disclosed herien were investigated in Examples 6-12. In these examples, the micronutrient formulations were designated as follows: MicroForm-2 comprised a mixture of sodium glucarate, glucaric acid, sodium gluconate, and gluconic acid; MicroForm-3 comprised glucaric acid and MicroForm-4 comprised a mixture of gluconic acid and citric acid

### Example 6

The ability of MicroForm-3 and MicroForm-2 to complex calcium were evaluated using calcium nitrate and calcium chloride salt respectively with the aid of alkaline solution to increase pH and solubility.

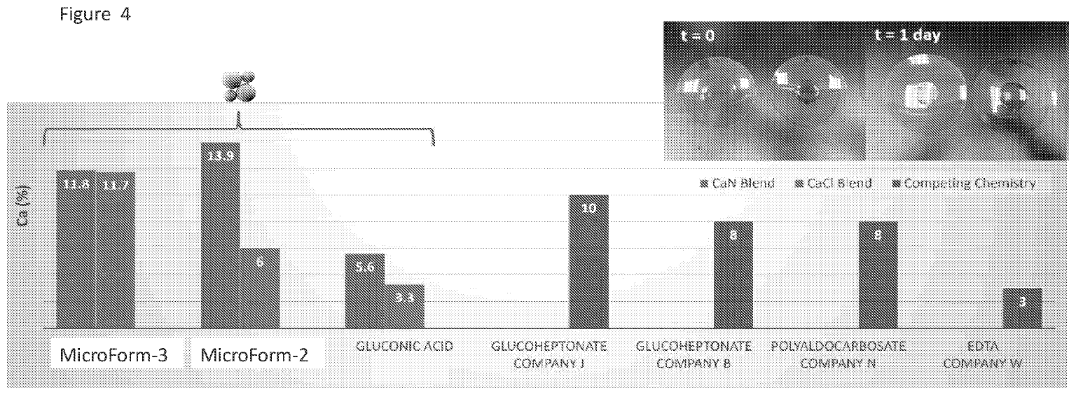

As shown in FIG. 4, calcium plant nutrition compositions having a micronutrient formulation of the type disclosed herein provided a larger amount of calcium chelated when compared to the commercially available calcium chelators such as glucoheptonate, polyaldocarbosate, and EDTA. Moreover, the highest calcium content (%) was achieved with the combination of MicroForm-2 and calcium nitrate.

With regard to FIG. 4, the inset pictures of watch glasses show the comparison of calcium nitrate in solution and calcium nitrate combined with a micronutrient formulation of the type disclosed herein at the initial stage and at day 1. At day 1, some of the calcium nitrate solution evaporated and the size shrank, while the nutrient solution comprising a micronutrient formulation of the type disclosed herein remained liquid which shows the micronutrient formulation had a humectant functionality.

### Example 7

A blend of a calcium source and a MicroForm, termed MicroBlend-CaX was prepared and its ability to aid in plant growth was compared to that of other calcium formulations. X is 1, 2, 3, or 4 referring to MicroForm-1, MicroForm-2, MicroForm-3 or MicroForm-4, respectively. The calcium sources used were calcium chloride, calcium nitrate, calcium formulated with glucoheptonate, calcium formulated with a sugar alcohol, and calcium formulated with an amino acid.

Lettuce plants were seeded and grown indoors under controlled lighting, temperature, using a fertilizer dosage of 100 ppm. A Microblend of the type disclosed herein was formulated as a solution and was sprayed onto the plants daily (i.e., treated) for 10 days and the calcium concentration was normalized to 600 ppm. For each treatment there were six replicate samples. After 10 days, lettuce treated with a Microblend of the type disclosed herein showed healthy plant growth without tip burn, and there was no evidence that the Microblends of the present disclosure harmed plant growth. However, lettuce treated with other products such as calcium formulated with glucoheptonate or amino acid calcium exhibited tip burn and/or nitrogen burn.

Another set of greenhouse tests were conducted with tomato plants to verify a MicroForm of the type disclosed herein had utility as a nutrition delivery platform. Specifically, tomato plants were seeded and grown indoor with controlled lighting, controlled temperature and utilizing a fertilizer dosage of 200 ppm. A Microblend-Ca of the type disclosed herein (e.g., having a calcium source) was formulated as a solution and was sprayed daily for 10 days and the calcium concentration normalized to 600 ppm. At final harvest collection, the plants were separated into shoot and root samples. The fresh and dry weights were measured and nutrient analysis conducted.

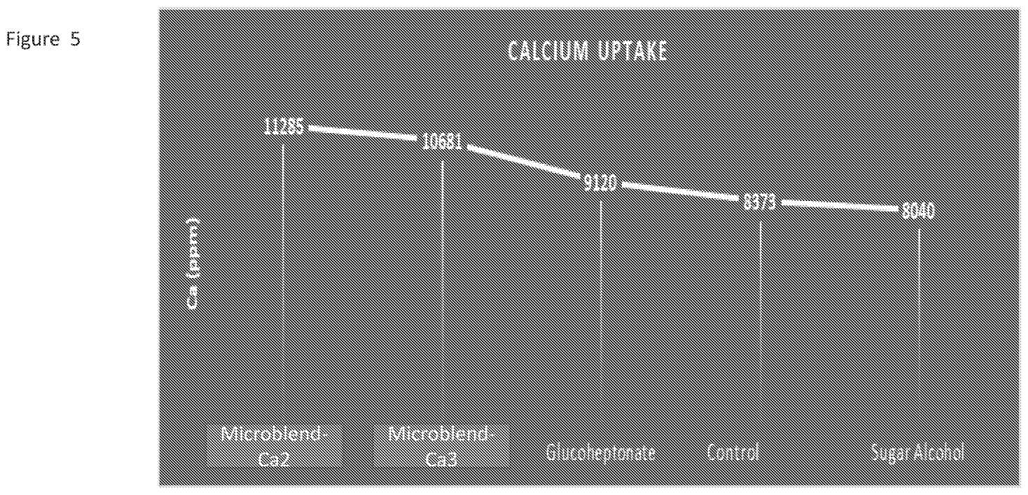

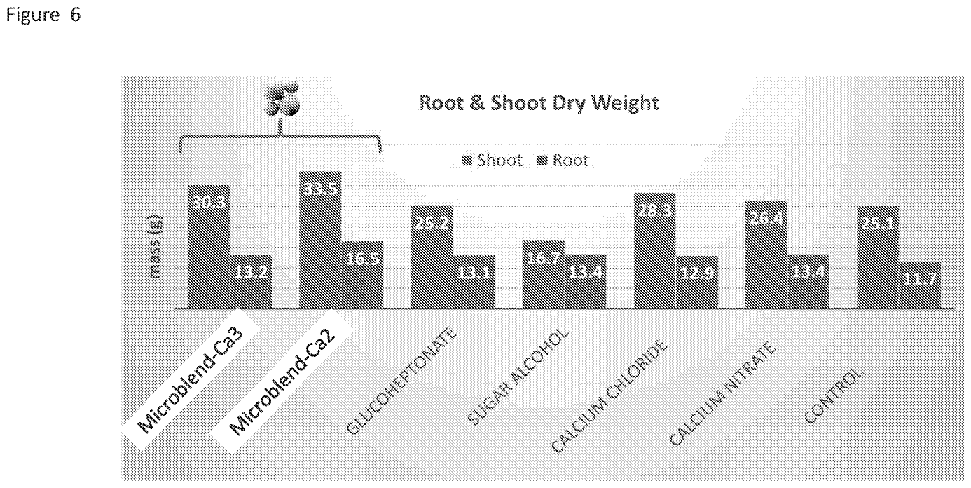

Treatment of tomato plants and fruits with Microblends of the type disclosed herein resulted in plants that lacked any sign of phytotoxicity and no blossom rot on the tomato. From the nutrition analysis of leaves at harvest, as depicted in FIG. 5, calcium nutrients formulated with Microblend-Ca2 and Microblend-Ca3 showed the highest amount of calcium uptake by the plant compared to other calcium liquid products such as glucoheptonate or a sugar alcohol. The tomato plants treated with Microblend-Ca2 or Microblend-Ca3 also showed the highest mass of shoot and equal to or higher root weight compared to the other calcium sources investigated, FIG. 6.

### Example 8

The ability of a micronutrient formulation of the type disclosed herein to increase the availability of magnesium to plants was investigated. Specifically, MicroForm-2 was used to form a blend with magnesium and boron using with the aid of alkaline solution to increase pH and solubility. Magnesium was present in the formulation as magnesium sulfate heptahydrate and the resultant blend is designated Microblend-Mg2.

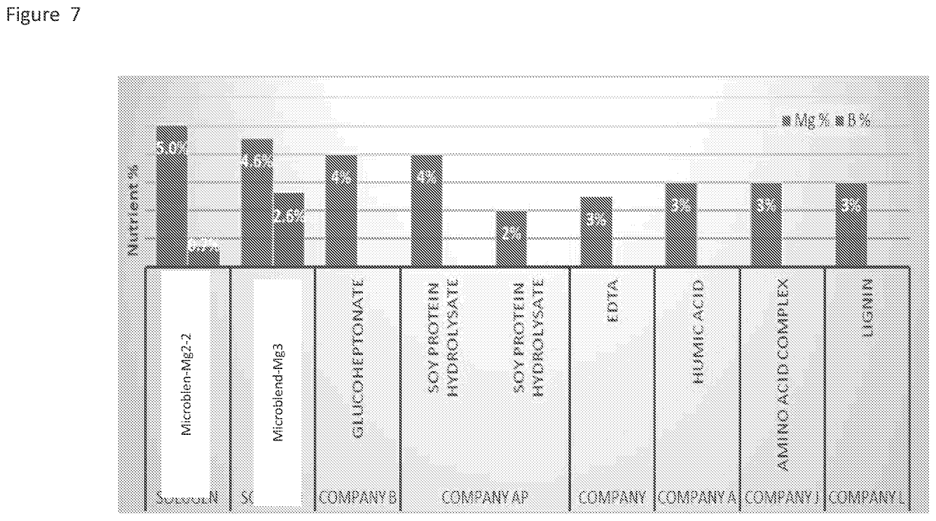

As shown in FIG. 7, magnesium plant nutrition formulated with Microblend-Mg2 led to the highest Mg % uptake by the plants when compared to the magnesium uptake when using compounds such as glucoheptonate, EDTA, humic acid, amino acid, and lignin. Moreover, Microblend-Mg2 allowed for the formulation of a composition having two different nutrients present such as magnesium and boron at relatively high concentration (2.6%) and at a high magnesium to boron ratio when compared to the other materials investigated.

### Example 9

The ability of a micronutrient formulation of the type disclosed herein to increase the availability of manganese to plants was investigated. Specifically, MicroForm-3 was used to form a blend with manganese and boron with the aid of an alkaline solution to increase pH and solubility. Manganese was present in the formulation as manganese sulfate heptahydrate and the resultant blend is designated Microblend-Mn3.

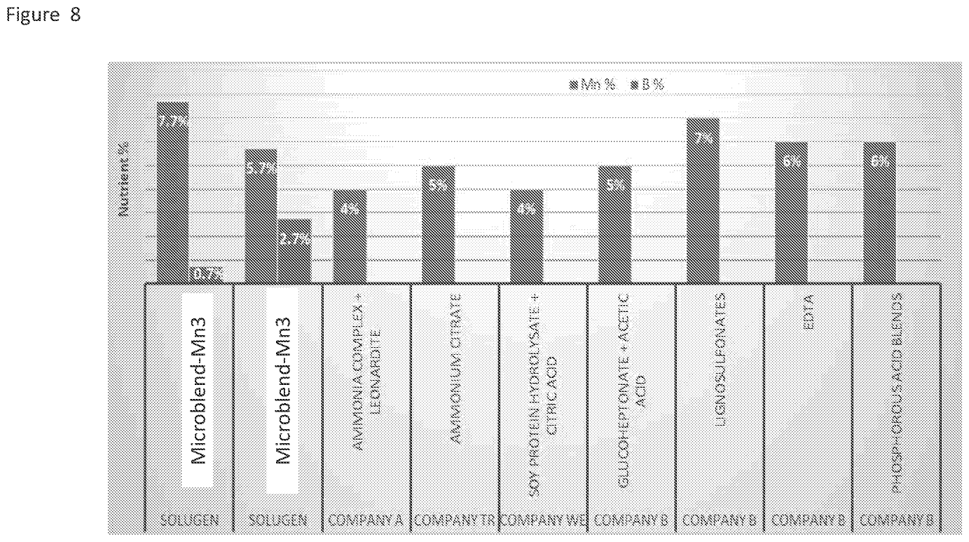

As shown in FIG. 8, manganese plant nutrition formulated with Microblend-Mn3 led to the highest Mn % uptake by the plants when compared to the manganese uptake when using compounds such as ammonia complex with leonardite, ammonium citrate, glucoheptonate, EDTA, amino acid, and ligninosulfates. Further, nutrient analysis demonstrated that Microblend-Mn3 was able to improve plant uptake of several different nutrients. For example, uptake of boron at higher boron rate (2.7%) was observed along with a higher manganese to boron ratio when compared to the other materials investigated.

### Example 10

The ability of a micronutrient formulation of the type disclosed herein to increase the availability of molybdenum to plants was investigated. Specifically, MicroForm-2 and MicroForm-3 were used to complex molybdenum (Mo) and boron using sodium molybdate dihydrate with the aid of alkaline solution to increase pH and solubility.

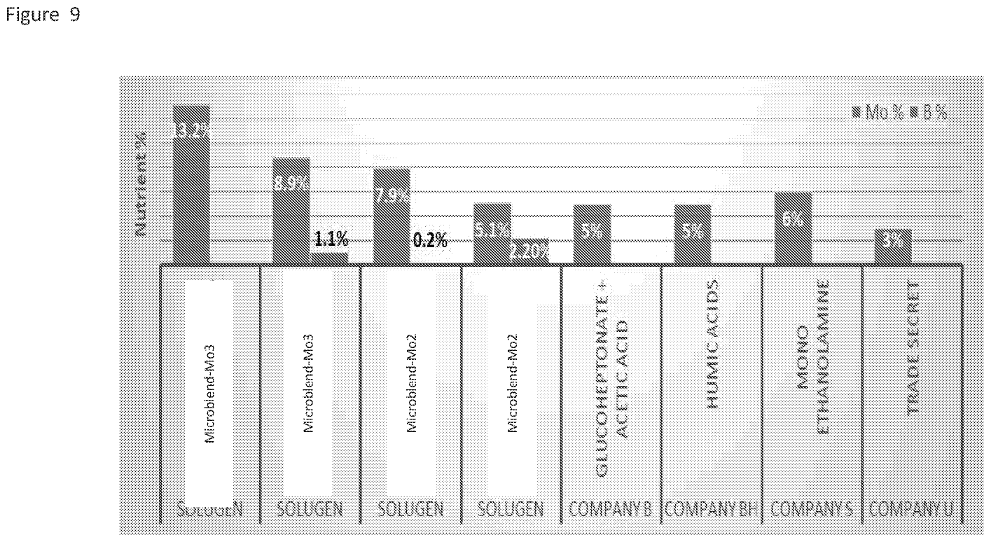

As shown in FIG. 9, molybdenum plant nutrition formulated with Microblend-Mo3 led to the highest Mo % uptake by the plants when compared to the molybdenum uptake when using compounds such as glucoheptonate, humic acid, Further, nutrient analysis demonstrated that Microblend-Mo3 was able to improve plant uptake of several different nutrients. For example, uptake of boron at higher boron rate (1.8%) was observed along with a higher molybdenum to boron ratio when compared to the other materials investigated.

Moreover, Microblend-Mo3 allowed for the formulation of a composition having two different nutrients present such as molybdenum and boron at relatively high concentration (2.7%) and at a high molybdenum to boron ratio.

### Example 11

The ability of a micronutrient formulation of the type disclosed herein to increase the availability of zinc to plants was investigated. Specifically, MicroForm-3 was used to form a blend with zinc and boron using zinc sulfate with the aid of alkaline solution to increase pH and solubility. The resultant blend was designated Microblend-Zn3.

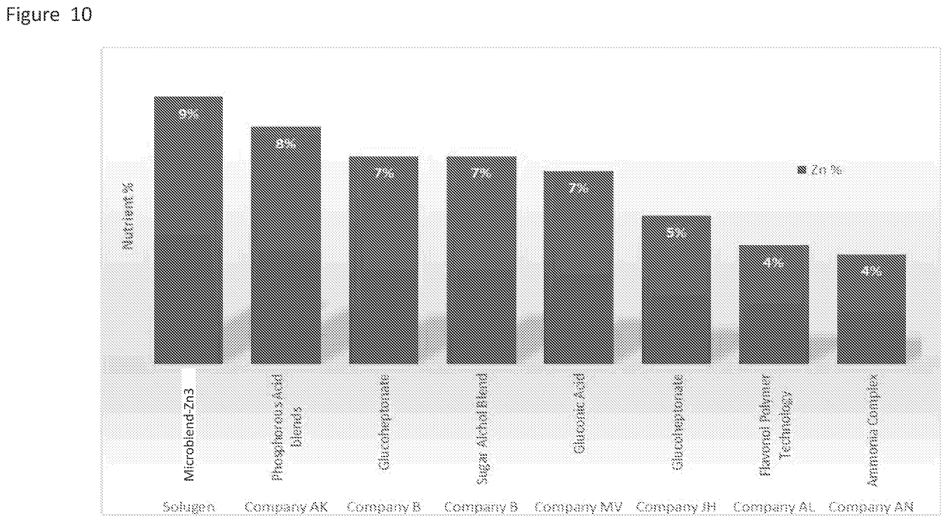

As shown in FIG. 10, zinc plant nutrition formulated with Microblend-Zn3 led to the highest Zn % uptake by the plants when compared to the zinc uptake observed when using compounds such as glucoheptonate, phosphorus acid blends or sugar alcohol. Moreover, Microblend-Zn3 allowed for the formulation of a composition having two different nutrients present such as zinc and boron at relatively high concentration (2.6%) and at a high zinc to boron ratio when compared to the other materials investigated.

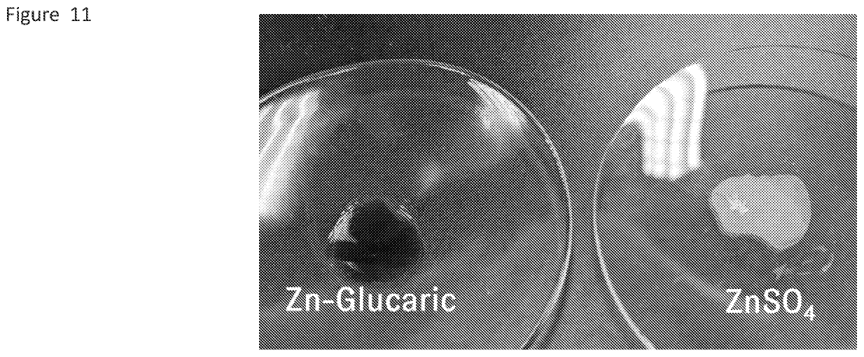

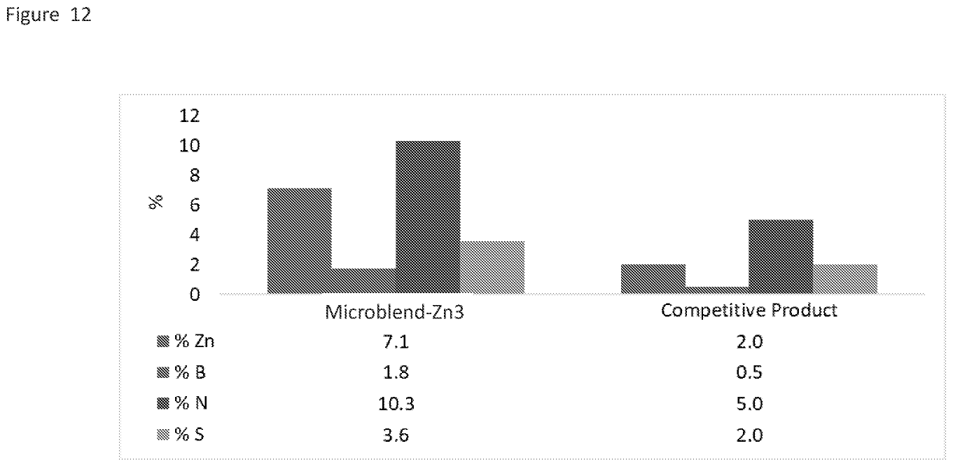

The humectant property of Microblend-Zn3 was compared to that of zinc sulfate (ZnSO₄). After one day of evaporation, the Microblend-Zn3 remained as a free-flowing liquid when compared to the behavior of ZnSO₄, FIG. 11. FIG. 12 depicts the results of nutrient analysis demonstrating that Microblend-Zn3 was able to improve plant uptake of several different nutrients. For example, uptake of boron at higher boron rate (1.8%) was observed along with a higher zinc to boron ratio wehn compared to the other materials investigated.

### Example 12

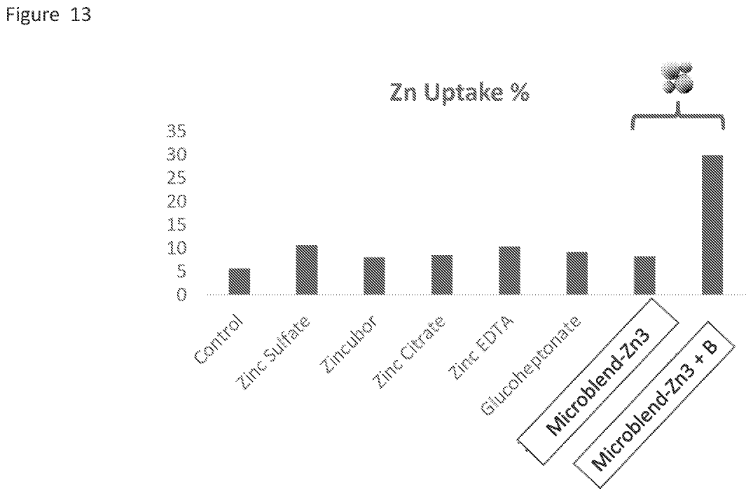

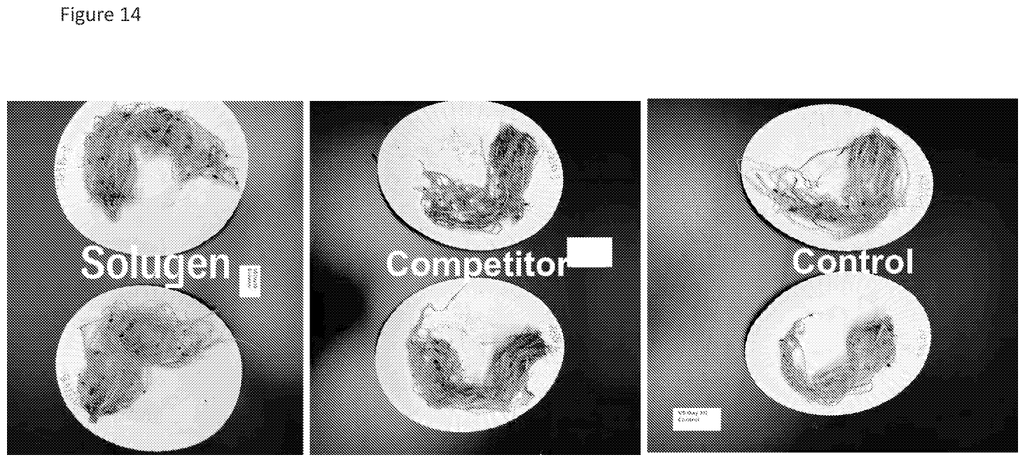

The effects of Microblend-Zn3 on plant growth and productivity was further investigated via a greenhouse test. Specifically, corn plants were seeded and grown indoors with controlled temperature and lighting. A liquid fertilizer was sprayed on corn leaves (foliar application) at V5 growth stage with the Zn concentration of each fertilizer treatment being controlled to 400 ppm. The liquid fertilizer samples used were a control sample, Microblend-Zn3, Microblend-Zn3 with boron, Zincubor, Zn Sulfate, Zn Citric acid, Zn Glucoheptonate and Zn EDTA. Plant tissue samples for nutritional analysis (ICP) were collected at 3&5 days after fertilizer treatment. At final harvest collection, the plants were separated into shoot and root samples to be weighed for fresh and dry weight and then analyzed for nutrient status. Based on the nutrition analysis of corn leaves at harvest as in FIG. 13, Microblend-Zn3 enabled as efficient zinc and boron uptake in corn as other materials investigated. However, Microblend-Zn3 with boron enabled 3-4× higher Zn uptake compared to any of the other products investigated. Microblend-Zn3 with boron yielded more complex & fibrous roots, while the non-chelated material (indicated as “competitor”) had roots similar to the control, FIG. 14.

While aspects of the disclosure have been shown and described, modifications thereof can be made without departing from the spirit and teachings of the presently disclosed subject matter. The aspects and examples described herein are exemplary only, and are not intended to be limiting. Many variations and modifications of the subject matter disclosed herein are possible and are within the scope of the present disclosure.

At least one aspect is disclosed and variations, combinations, and/or modifications of the aspect(s) and/or features of the aspect(s) made by a person having ordinary skill in the art are within the scope of the disclosure. Alternative aspects that result from combining, integrating, and/or omitting features of the aspect(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, 5, 6, . . . ; greater than 0.10 includes 0.11, 0.12, 0.13, 0.14, 0.15, . . . ). For example, whenever a numerical range with a lower limit, Rl, and an upper limit, Ru, is disclosed, any number falling within the range is specifically disclosed. In particular, the following numbers within the range are specifically disclosed: R=Rl+k* (Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent . . . 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the detailed description of the presently disclosed subject matter.

1. A micronutrient formulation comprising a biochelant, a micronutrient salt, a ring opener and a solvent.

2. The formulation of claim 1, wherein the biochelant comprises an aldonic acid, uronic acid, aldaric acid, galactonic acid, galactaric acid oxidation product comprising predominantly galactonic acid, galactaric acid with minor component species of n-keto-acids and C₂-C₆ diacids or combinations thereof.

3. The formulation of claim 1, wherein the biochelant further comprises a counter cation.

4. The formulation of claim 3, wherein the counter cation comprises a Group 1 alkali metal, a Group 2 alkaline earth metal, a Group 8 metal, a Group 11 metal, a Group 12 metal or combinations thereof.

5. The formulation of claim 3, wherein the counter cation comprises silicates, borates, aluminum, calcium, magnesium, ammonium, sodium, potassium, cesium, strontium, zinc, copper, ferric iron or ferrous iron, or combinations thereof.

6. The formulation of claim 1, wherein the biochelant comprises a buffered glucose oxidation product, a buffered gluconic acid oxidation product or combinations thereof.

7. The formulation of claim 6, wherein the buffered glucose oxidation product, the buffered gluconic acid oxidation product or combinations thereof further comprises n-keto-acids, C₂-C₆ diacids or combinations thereof.

8. The formulation of claim 1, wherein the biochelant is present in an amount of from about 0.1 weight percent (wt. %) to about 99 wt. % based on the total weight of the formulation.

9. The formulation of claim 1, wherein the micronutrient salt comprises boron, iron, cobalt, copper, magnesium, manganese, zinc, potassium, aluminum, urea, calcium, molybdenum, or combinations thereof.

10. The formulation of claim 1, wherein the micronutrient salt comprises, oxides of iron, magnesium, manganese, copper, zinc, calcium, potassium, or combinations thereof.

11. The formulation of claim 1, wherein the micronutrient salt comprises humic acids, fulvic acids, salts thereof, or combinations thereof.

12. The formulation of claim 1, wherein the ring opener comprises oxoacid salt, an amide, or combinations thereof.

13. The formulation of claim 1, wherein the ring opener comprises silicic acid, sodium silicate, potassium silicate, monosilicate, silanes, siloxanes, amino acids, urea, boric acid, aluminates, stannates, titanates, urea, acetamide, ethanamide, derivatives thereof, or combinations thereof.

14. The formulation of claim 1, wherein the ring opener comprises methylol urea, imidazolidinyl urea, ethylene urea, diazolidnyl urea, or combinations thereof.

15. The formulation of claim 1, wherein the ring opener comprises boron, borate borax, sodium borates, metaborate, perborate, potassium borates, diammonium tetraborate, boron trioxide, or combinations thereof.

16. The formulation of claim 1, further comprising an optional facilitating agent.

17. The formulation of claim 1 wherein the optional facilitating agent comprises sodium citrate, potassium citrate, potassium gluconate, or combination thereof.

18. The formulation of claim 1, wherein the solvent comprises water, a citrate solution, or combinations thereof.

19. A method of treating a plant comprising applying a treatment composition comprising a biochelant, a micronutrient salt, a ring opener and a solvent to an area selected from the group consisting of foliar, soil, fertigation, chemigation, irrigation, hydroponics, aeroponic, indoor vertical farming, to the ground surrounding a plant, to plant foliage, by drip irrigation, and combinations thereof, wherein treatment composition comprises a biochelant, a micronutrient salt, a facilitating agent and a solvent.

20. The method of claim 19, wherein the biochelant comprises an aldonic acid, uronic acid, aldaric acid, galactonic acid, galactaric acid oxidation product comprising predominantly galactonic acid, galactaric acid with minor component species of n-keto-acids and C₂-C₆ diacids, or combinations thereof.

21. The method of claim 19, wherein the micronutrient salt comprises boron, iron, cobalt, copper, magnesium, manganese, zinc, potassium, aluminum, urea, calcium, molybdenum, or combinations thereof.

22. The method of claim 19, wherein the ring opener comprises oxoacid salt, an amide, or combinations thereof.

23. The method of claim 19, wherein the ring opener comprises silicic acid, sodium silicate, potassium silicate, monosilicate, silanes, siloxanes, amino acids, urea, boric acid, aluminates, stannates, titanates, urea, acetamide, ethanamide, derivatives thereof, or combinations thereof.

24. The method of claim 19, wherein the ring opener comprises methylol urea, imidazolidinyl urea, ethylene urea, diazolidnyl urea or a combination thereof.

25. The methodology of claim 19, wherein the ring opener comprises boron, borate borax, sodium borates, metaborate, perborate, potassium borates, diammonium tetraborate, boron trioxide, or combinations thereof.
